(19) United States
(12) Patent Application Publication
(10) Pub. No.: US 2025/0285377 A1
(43) Pub. Date: Sep. 11, 2025

(54) 3D SCENE RECONSTRUCTION USING POINT CLOUDS AND DEEP LEARNING

(71) Applicant: QUALCOMM Incorporated, San Diego, CA (US)

(72) Inventors: Pirazh KHORRAMSHAHI, San Diego, CA (US); Gokce DANE, San Diego, CA (US); Adithya Reddy NALLABOLU, San Diego, CA (US); Upal MAHBUB, Santee, CA (US); Vasudev BHASKARAN, San Diego, CA (US)

(21) Appl. No.: 18/596,530

(22) Filed: Mar. 5, 2024

(51) Int. Cl. G06T 17/20; G06T 15/08

(52) U.S. Cl. CPC G06T 17/20; G06T 15/08

(57) ABSTRACT

Certain aspects of the present disclosure provide techniques for performing 3D scene reconstruction. Such techniques may include obtaining a plurality of voxels of a 3D voxel grid representing a scene including one or more objects; identifying a subset of voxels, from the plurality of voxels, that are within a threshold distance of one or more surfaces of the one or more objects based on depth information associated with a plurality of two-dimensional (2D) images of the scene; generating a point cloud comprising a set of point data structures corresponding to the subset of voxels; and processing the point cloud to reconstruct a 3D representation of the scene.

### FIELD OF THE DISCLOSURE

Aspects of the present disclosure relate to computer vision, and more particularly, to techniques for reconstructing three-dimensional scenes.

### DESCRIPTION OF RELATED ART

Techniques for generating three-dimensional (3D) models of scenes (e.g., environments, 3D spaces, etc.) have applications in various fields, including robotics, augmented/virtual reality, and autonomous vehicles. In particular, reconstructing a 3D representation of a scene in an end-to-end manner from two-dimensional (2D) images of the scene taken from multiple views (referred to as multi-view 2D images), such as by generating a 3D representation of the scene, such as a truncated signed distance function (TSDF), using deep learning techniques, has gained significant attention. A TSDF may be a simplified version of a signed distance function (SDF), which is a mathematical function that describes the distance between any point in space and the nearest point on a given service. In TSDF, the range of distances are limited or truncated, such that only distances up to a certain threshold are considered, and distances beyond the threshold are not considered.

For example, such deep learning techniques for reconstructing a 3D representation of a scene may include a pipeline that starts by aggregating visual features of the 2D images into a voxel grid, covering a large space and therefore including numerous voxels. The voxel grid may be processed through a neural network, such as a neural network including dense 3D convolutional or transformer layers, to generate the 3D representation of the scene (e.g., TSDF). Such a neural network may have heavy demands on computing resources and memory resources, especially due to the large number of voxels in the voxel grid to be processed. The demand on resources may be exacerbated as the voxel grid resolution is increased, such as when finer detail is desired in the reconstruction.

Despite the high resource demand of such techniques, some techniques have been introduced to try to make the 3D reconstruction process real-time, such as by fragmenting the voxel grid into fragments, and gradually performing the reconstruction on fragments in real-time. However, the neural network itself still remains a bottleneck, since such a large number of voxels are processed in the voxel grid, including voxels that may cover free space (referred to as empty voxels). The processing of such empty voxels may be inevitable due to the nature of the dense layers of the neural network.

Some techniques attempt to utilize a neural network with sparse 3D convolutional layers, such as to avoid processing of empty voxels. However, use of such a neural network may require significant overhead, and may not be computationally efficient, especially for voxel grids that do not have a large number of empty voxels.

### SUMMARY

One aspect provides a method for performing 3D scene reconstruction. In certain aspects, the method may include obtaining a plurality of voxels of a 3D voxel grid representing a scene including one or more objects; identifying a subset of voxels, from the plurality of voxels, that are within a threshold distance of one or more surfaces of the one or more objects based on depth information associated with a plurality of two-dimensional (2D) images of the scene; generating a point cloud comprising a set of point data structures corresponding to the subset of voxels; and processing the point cloud to reconstruct a 3D representation of the scene.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIGS. 1A-1B depict details for performing 3D scene reconstruction, in accordance with some aspects of the present disclosure.

FIG. 2 depicts an example voxel selection process utilized to generate a point cloud based on depth map information, in accordance with examples of the present disclosure.

FIG. 3 depicts an example of a reconstructed 3D scene in accordance with examples of the present disclosure.

FIG. 4 depicts additional details of an implementation for generating point cloud data leveraging a previously reconstructed 3D scene, in accordance with examples of the present disclosure.

FIG. 5 illustrates an example artificial intelligence (AI) architecture that may be used for AI-enhanced wireless communications.

FIG. 6 illustrates an example AI architecture of a first wireless device that is in communication with a second wireless device.

FIG. 7 illustrates an example artificial neural network.

FIG. 8 depicts an example method for performing 3D scene reconstruction.

FIG. 9 depicts aspects of an example device.

### DETAILED DESCRIPTION

Aspects of the present disclosure provide apparatuses, methods, processing systems, and computer-readable mediums for performing 3D scene reconstruction.

As discussed, there is a technical problem in 3D scene reconstruction in that current techniques for 3D scene reconstruction using deep learning is computing resource and memory resource intensive. This may make 3D scene reconstruction take a long time on some devices, or may mean certain devices cannot perform 3D scene reconstruction. Certain aspects discussed herein provide techniques for 3D scene reconstruction that may provide a technical solution to the technical problem, such as by providing the technical benefit of reduced computing resource and/or memory resource requirement for 3D scene reconstruction.

For example, certain aspects provide techniques where a voxel grid representing a scene is converted into a point cloud. The point cloud may be sparser than the voxel grid, meaning only a subset of the voxels of the voxel grid are used to generate the point cloud. A subset of elements, as used herein, may refer to less than all of the elements. The subset of voxels may be selected from among the voxels of the voxel grid based on their proximity to one or more surfaces of object(s) in the scene. The determination of proximity of the voxels to the one or more surfaces may be based on depth information associated with the voxels (e.g., derived from one or more images of the scene, based on one or more depth sensors, etc.). Accordingly, the point cloud may represent surfaces of objects in the scene, as opposed to entire volumes of objects. Such surfaces of objects in the scene may be sufficient to reconstruct the scene in 3D, without having to process all the voxels of the voxel grid. The point cloud may be used to perform the 3D scene reconstruction instead of the voxel grid. Performing the 3D scene reconstruction using the point cloud may provide the technical benefit of reduced computing resource and/or memory resource requirement for 3D scene reconstruction, such as due to the reduced number of points in the point cloud as compared to voxels in the voxel grid. Further, the selection of the subset of voxels for generating the point cloud based on proximity to one or more surfaces may be less computationally intensive than using sparse 3D convolutional layers, providing additional technical benefit over other techniques.

For example, the point cloud may include a set of point data structures. A set of elements as used herein may refer to one or more elements. Each point data structure may include a 3D position of the point data structure, which may be a 3D grid coordinate location in the voxel grid of a voxel represented by the point data structure. Each point data structure may further include one or more feature vectors (e.g., aggregated feature vectors) representing the voxel represented by the point data structure. In some cases, the one or more feature vectors may further represent one or more neighbor (e.g., within a threshold distance) voxels of the voxel represented by the point data structure.

In certain aspects, the point cloud is input into a machine learning (ML) model that is configured to reconstruct a 3D representation of the scene. The ML model may be, for example, a point-voxel (PV) convolutional neural network (CNN), which may be configured to taking input data in points, and perform convolutions on voxels. Such a ML model using the point cloud as input may provide the benefit of computing and/or memory resource efficiency over ML models using voxel grids as input, as discussed.

### Example Operations Related to 3D Scene Reconstruction

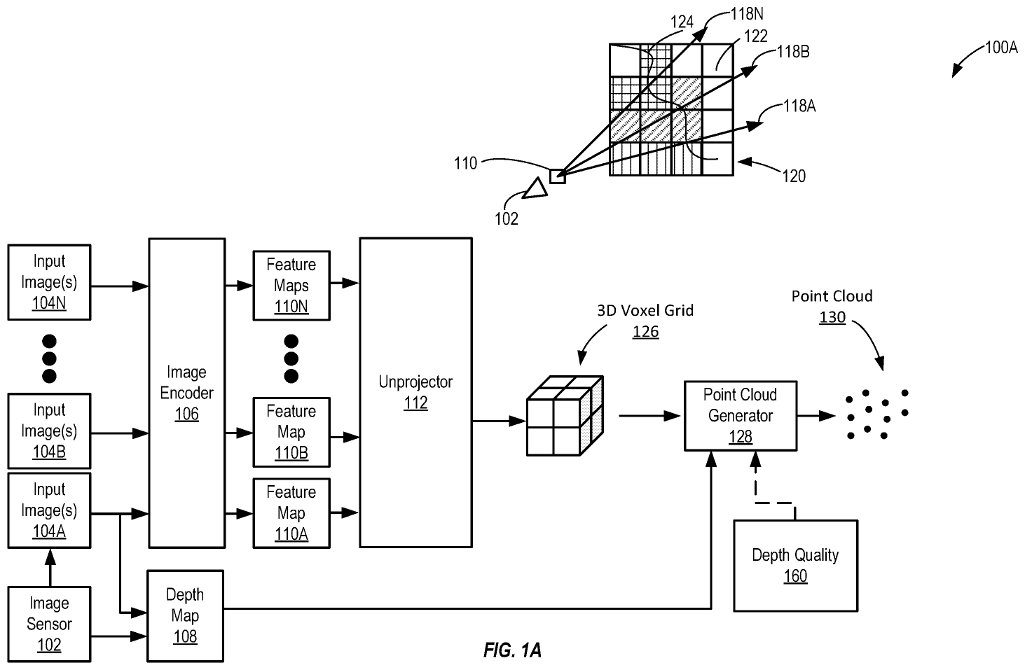

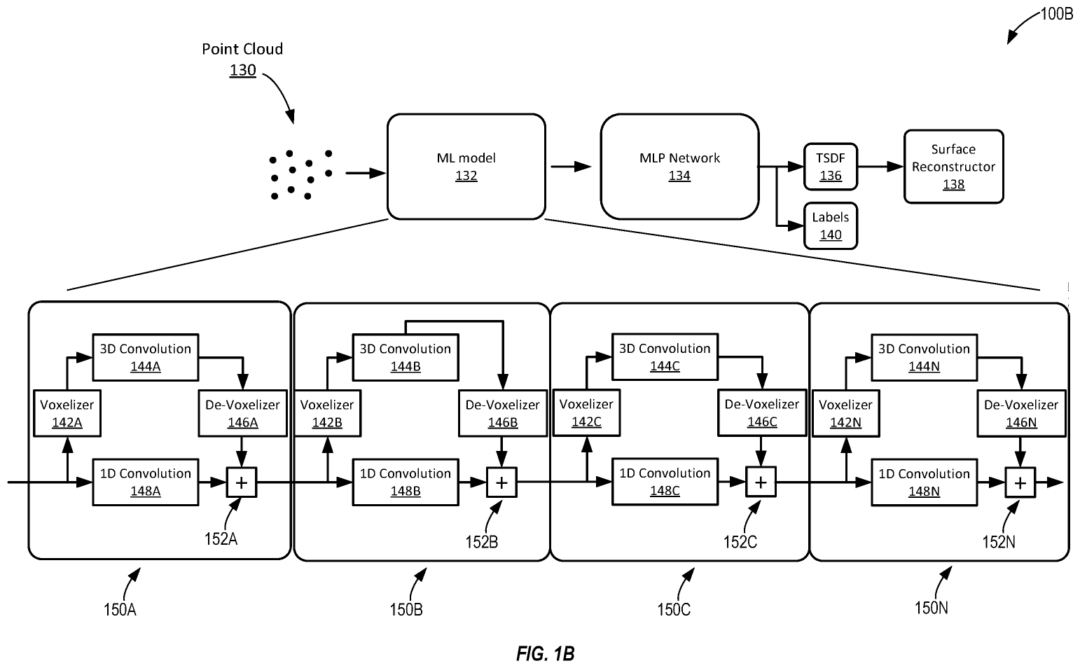

FIG. 1A depicts details of a system 100A for performing 3D scene reconstruction. The system 100A can obtain a plurality of images of a scene 104A-104N from one or more image sensor(s) 102. The input images 104A-104N include image data representing one or more objects in the scene. The one or more image sensor(s) 102 may comprise a sensor or combination of sensors configured to capture images (e.g., RGB images) of a three-dimensional scene. In examples, the image sensor(s) 102 comprise one or more digital camera sensor(s) utilizing charge-coupled device (CCD) or complementary metal-oxide semiconductor (CMOS) technology. The image sensor(s) 102 may further comprise optic components including but not limited to lenses, apertures, filters, prisms etc. to facilitate image capture.

In some aspects, the image sensor(s) 102 comprise a plurality of image capture devices with overlapping fields of view of the scene to obtain images from different viewpoints 104A-104N. Thus, the input images 104A-104N captured by the image sensor(s) 102 can include two-dimensional digital representations of surfaces of one or more objects in the scene captured from different viewpoints. In some aspects, the viewpoints correspond to different positions of a single image sensor 102 capturing images sequentially. Alternatively, the viewpoints may correspond to (e.g., simultaneous) image capture from multiple distinct imaging devices. In some aspects, each input image 104 comprises a two-dimensional pixel array with each pixel having an associated pixel color value and pixel depth value. The pixel depth values for input images 104A-N cumulatively form the depth map 108 for the plurality of input images. While three input images 104A-104N are illustrated in FIG. 1A, any number of input images 104 from multiple viewpoints may be utilized. The multi-perspective image data from the input images 104A-104N facilitates reconstruction of the three-dimensional scene by the system 100A.

In some aspects, the image sensor(s) 102 can provide the captured input images 104A-104N to the image encoder 106 for encoding. In some implementations, the system 100A may generate the depth map 108 for the acquired input images 104A-104N, such as based on the input images 104A-104N themselves, such as via techniques such as stereoscopic depth imaging, monocular depth estimation, structured light depth imaging, time-of-flight depth imaging, or other approach to obtain per-pixel depth values for one or more depth maps 108 associated with the input images 104A-104N. In certain aspects, the system 100A may receive depth information to generate the depth map 108 or the depth map 108 itself, such as from one or more depth sensors that may be co-located with the one or more image sensors 102.

In some aspects, the image encoder 106 is configured to generate a plurality of encoded feature representations, or feature maps 110A-110N, associated with pixels of the plurality of input images 104A-N. In examples, the image encoder 106 can be a convolutional neural network image encoder configured to generate at least one feature vector per pixel corresponding to one or more of the input images 104A-104N. For example, the image encoder 106 can be configured to receive pixel color values across the plurality of input images 104A-N and generate an encoded feature representation, or feature map 110, for each input image 104A-104N. The feature maps 110A-110N may include feature vectors representing visual characteristics for each perspective view of the scene. In some examples, this includes generating at least one d-dimensional feature vector for each pixel in the input images 104A-N, where d represents the length of the feature encoding vector. As one example, the image encoder 106 utilizes 32 or 16 dimensional feature vectors. The feature vectors generated by the image encoder 106 are subsequently back-projected into the 3D voxel grid 126 by the unprojector 112 utilizing the depth map 108 to align pixels for each input image as represented by feature maps 110A-110N associated with respective input images 104A-104N.

For example, the unprojector 112 may be configured to back-project the plurality of feature maps 110A-110N into a plurality of voxels of a 3D voxel grid 126 that is associated with a scene. In certain aspects, the unprojector 112 determines back-projected positions of feature vectors, from the feature maps 110A-110N, in the 3D voxel grid 126 utilizing location/pose information associated with a particular viewpoint (e.g., viewpoint of image sensor 102) along with depth values from the depth map 108 for each paired input image 104 and feature map 110. In some examples, viewpoint rays 118A-118N are cast from the location or origin of the viewpoint associated with the image sensor 102 through the encoded feature maps 110A-110N; thus, encoded feature vectors from corresponding feature maps 110A-110N are mapped to one or more voxels 122 of the voxel grid 120 which fall along rays 118A-118N cast from the image sensor 102 origin point. This results in back-projection and aggregation of feature vectors within voxels that are generally visible in the plurality of input images 104A-104N.

In some examples, viewpoint rays 118A-118N are cast from the location or origin of the view point associated with image sensor 102 through object surfaces 124 as indicated from the depth map 108. That is, utilizing depth map 108 data, intersection points of the rays 118A-118N and object surfaces 124 are determined along each ray direction. Encoded feature vectors from corresponding feature maps 110A-110N are mapped to one or more voxels 122 of the voxel grid 120 which fall along rays 118A-118N cast from the image sensor 102 origin point. This results in back-projection and aggregation of feature vectors within voxels that are near object surfaces and that are generally visible in the plurality of input images 104A-104N.

In certain aspects, the output of the unprojector 112 includes populated 3D voxel grid 126. Though certain aspects are described with respect to system 100A generating the populated 3D voxel grid 126, it should be understood that the populated 3D voxel grid 126 may be obtained from elsewhere, such as a voxel grid generated by another device or devices, or may be generated by system 100A in a different manner. In some implementations, voxel information for one or more voxels in the 3D voxel grid 126 may contain information identifying the voxel as a subset of voxels proximal to object surfaces. For example, a voxel may include or otherwise be associated with information (e.g., metadata, tag, label, etc.) identifying the voxel as a voxel belonging to a group of voxels; in some examples, the group of voxels may be proximal to one or more object surfaces. Subsequent processing utilizes the voxel subset data for generation of point cloud 130 and further 3D scene reconstruction. In some implementations, the 3D voxel grid 126 comprises a plurality of voxels spatially organized into a grid structure along width, height, and depth dimensions of predetermined resolution to represent surfaces and/or objects in the scene. In some implementations, the 3D voxel grid 126 has known fixed dimensions, such as 96×96×96 voxels. In some implementations, the resolution of the 3D voxel grid 126 in one or more planes matches a pixel resolution of aligned components such as depth map 108. In some implementations, the voxel grid 126 resolution may be different than the resolution of the input images 104A-104N, feature maps 110A-110N, and/or the depth map 108.

In some examples, each voxel in the 3D voxel grid 126 is assigned a unique index. The index values allow iterative accessing of any arbitrary voxel within the three-dimensional array structure of the 3D voxel grid 126 based on ordinal positioning along the width, height, and depth grid axes. As one example, the 3D voxel grid 126 indices may enumerate linear voxel sequences across the width and height planes while stepping along the depth axis. This known positional index mapping allows the unprojector 112 to directly access assigned voxels during back-projection operations. Based on geometric calculations of ray traces 118A-N from positions of the image sensor 102 guided by depth map 108 surface intersections, the unprojector 112 is able to place input image viewpoint feature vectors into specific target voxel indices proximate to surfaces in the scene. Thus, one or more subsequent operations can then selectively identify and iterate through the subset of proximal surface voxels for subsequent point cloud generation.

In some implementations, the system 100A may further utilize a point cloud generator 128 configured to identify the subset of the plurality of voxels that are within a threshold distance of one or more object surfaces in the scene. The identified voxel subset is used to generate a point cloud 130 comprising a set of point data structures. In some implementations, the system 100A comprises additional components configured to further process the generated point cloud 130 to reconstruct a 3D representation of the scene as detailed in FIG. 1B. For example, one or more proximity evaluations can compare voxel depth values, derived from ordinal grid positioning, to pixel depth values from the depth map 108, which have been back-projected into specific voxels by the unprojector 112. A depth threshold can then be applied to determine qualifying surface proximal voxels—for example, by comparing voxel depth dᵥ to respective back-projected pixel depth zᵥ and selecting voxels where the difference is less than or equal to a threshold value. In certain aspects, the threshold value can control a density of a resulting point cloud 130, where smaller thresholds result in sparser point clouds 130 containing only voxels close to surfaces, while larger thresholds capture more surrounding voxels and surface detail at the expense of more point cloud 130 noise. The selected proximal voxels are then utilized as a voxel subset for subsequent processing.

In some examples, a depth quality module 160 can be configured to assess an accuracy of per-pixel depth values of the depth map 108 associated with the input images 104A-N. As previously discussed, the depth values are used for back-projection by unprojector 112 as well as a proximal filter to identify voxels proximal to an object surface by the point cloud generator 128. However, some depth sensing modalities such as stereoscopic or monocular depth imaging may suffer noise or missing depth values which could hinder the reconstruction process. Thus, in some implementations, the depth quality module 160 generates one or more confidence metrics for existing sensor depth values and/or performs gap-filling to estimate missing depths at a reduced confidence. Unreliable points can optionally be excluded by thresholding low depth confidence scores.

FIG. 1B depicts details of a system 100B for processing the generated point cloud 130 to reconstruct surfaces of a 3D scene. The point cloud 130 comprises a set of point data structures, where each point structure may include, but may not be limited to, a 3D grid coordinate location corresponding to an associated voxel's positional index, stored as a 3D position, and aggregated d-dimensional feature vectors from multiple input images 104A-104N, stored as point cloud feature vectors.

To process the point cloud 130, the system 100B can utilize an ML model 132, which may generate feature representations from the points of the point cloud 130. In some aspects, the ML model 132 includes a sequence of point-voxel convolutional neural network modules 150A-150N. The modules 150A-150N perform a series of localized point transformations by applying 3D convolutions to neighboring points.

Each module 150 starts by voxelizing local point neighborhoods using a voxelizer 142. Voxelizers 142 allocate points into voxel grids of fixed size (e.g. 32×32×32) to capture local geometric contexts. The voxelized grids are convolved using a 3D convolutional neural network 144, such as a two-layer 3D convolutional neural network having a convolutional filter kernel size, such as of 3. For example, the voxelizer 142A allocates input point cloud data structures into a temporary three-dimensional voxel grid structure of predetermined fixed size, such as 32×32×32 voxels. The voxelized grid then undergoes 3D convolutions using a first 3D convolutional neural network 144A having multiple convolutional layers, such as having a 3×3×3 voxel cubic filter kernel. This extracts voxel-based feature transformations. A first de-voxelizer 146A then de-voxelizes the convolved voxel grid to map extracted voxel features back into aggregated point feature representations.

In certain aspects, de-voxelized feature points may undergo additional convolutions, for example a one-dimensional convolution 148, to capture wider spatial contexts across broader point cloud areas. In examples, earlier module outputs can then be merged with latest outputs using a summer 152 at each stage. These point-voxel convolutional sequences transform input point cloud features into higher-dimensional abstractions that can be used for object surface generation. As illustrated in FIG. 1B, additional network modules 150B-15ON repeat similar sequences of localized point-voxel convolutions with de-voxelizations, additional convolutions, and concatenations.

The feature representations from the ML model 132 corresponding to points in the point cloud 130 are passed into a multi-layer perceptron (MLP) network 134. In certain aspects, the MLP network 134 includes one or more fully connected layers to map point features into TSDF prediction values 136, where the TSDF prediction values indicate scene surface distances and orientations. That is, a TSDF encodes an oriented surface distance at a 3D point. Encoded surface orientations allow reconstruction of closed mesh geometries. The predicted TSDF values 136 for all point locations collectively define a volumetric surface representation for the scene. In certain aspects, this volumetric output enters a surface reconstructor 138 which converts the TSDF volume into 3D triangle mesh representations encoding reconstructed scene surfaces for user display and rendering. In some implementations, the surface reconstructor 138 may utilize a marching cubes algorithm or other inverse-distance volume rendering techniques to generate meshes. The resulting 3D mesh comprises a reconstructed 3D visual representation of visible surfaces based on the input images 104A-104N.

In some examples, and as illustrated in FIG. 1B, the system 100B may incorporate surface semantic labels 140 to enhance reconstruction accuracy for known objects during the surface reconstruction process. In certain implementations, input images 104A-104N may undergo semantic segmentation using standard machine learning techniques to classify pixels into known scene categories like walls, floors, furniture items, props, etc. Classified semantic labels 140 for visible surfaces can guide point and/or voxel processing at subsequent processing stages. For example, the unprojector 112 may utilize known geometric properties and constraints of labeled surface types during back-projections into the voxel grid 126. The ML model 132 can similarly use labels to refine point cloud transformations that are appropriate to each semantic class. As an example, label-aware transformation refinement may retain sharp edges on recognized objects, enforce planar flatness for walls, etc. As another example, the surface reconstructor 138 can constrain the generation of surfaces, such as meshes, to fitting labeled categories. As an example, a surface reconstructor 138 can restrict surfaces and meshes to chair or table reconstruction expected forms based on the semantic labels 140.

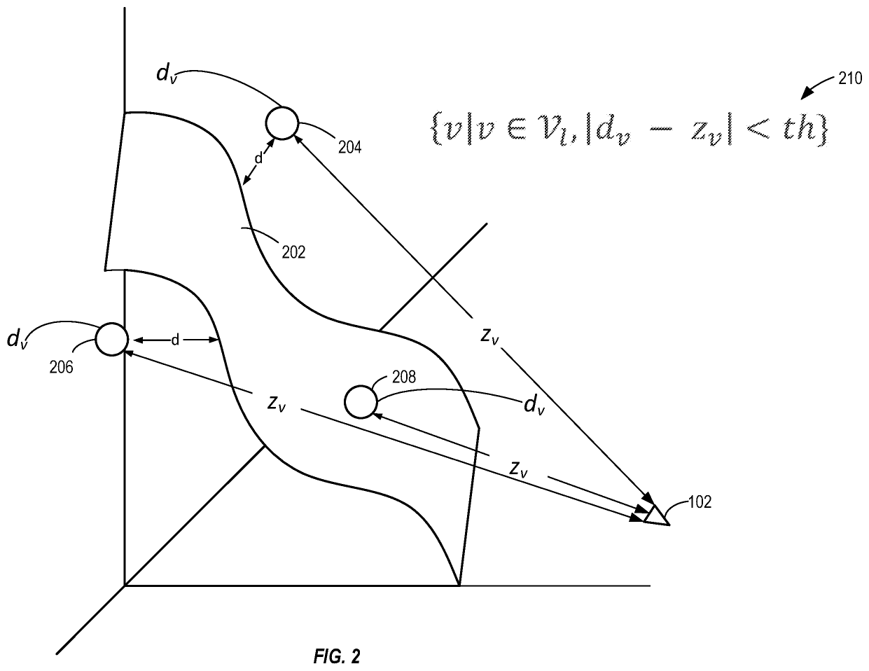

FIG. 2 illustrates an example voxel selection process utilized to generate point cloud 130 based on depth map 108 information. The voxel distance values, dᵥ, represent voxel distances based on voxel positions in the 3D voxel grid 126 (FIG. 1A). The depth map 108 comprises respective per-pixel depth estimates, zᵥ, providing measured distance to visible scene surfaces intersected by view rays 118 (FIG. 1A). To select voxels proximate to actual object surfaces (e.g., 202) for point cloud conversion, respective voxel positions dᵥ and paired measured depths zᵥ are compared using a threshold criteria (e.g., 210), where |zᵥ−dᵥ| is less than or equal to a threshold value.

Voxels meeting threshold tests are considered surface proximal voxels to include in final point cloud 130 (FIG. 1A). Example voxels 204, 206, and 208 are displayed in relation to the surface 202. Any one of the voxels 204, 206, and/or 206 may be selected and included in the final point cloud 130 (FIG. 1A). Applying similar depth-guided threshold constraints across one or more voxels in the 3D voxel grid 126 (FIG. 1A) can produce a final point cloud 130 containing only those voxels proximal to scene surfaces.

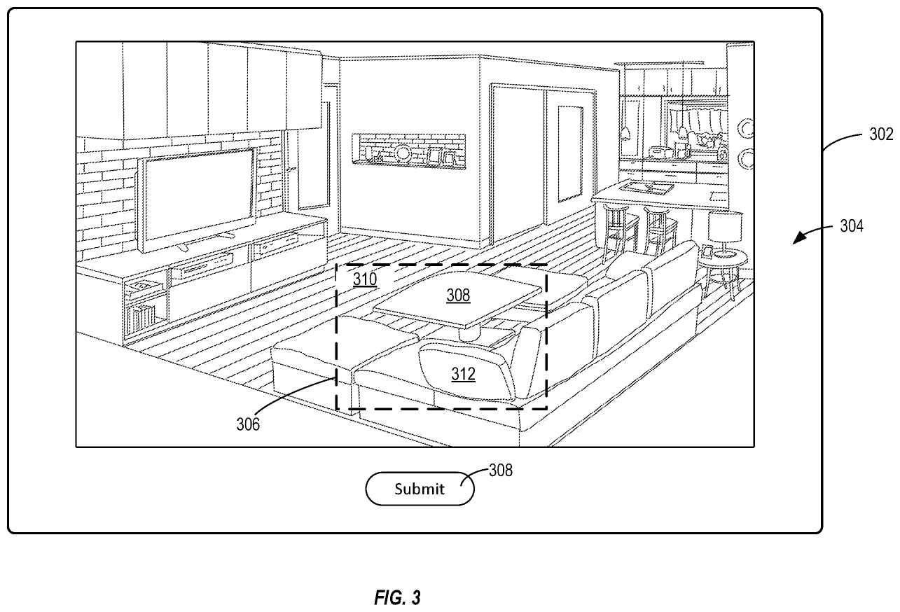

FIG. 3 depicts an example of a reconstructed 3D scene in accordance with examples of the present disclosure. In examples, a display component 302, such as a mobile phone or tablet, generates a graphical user interface (GUI) presentation of an image having a reconstructed 3D surface, such as the surface of the table 308, chair 312, and/or floor 310. In some examples, the image including the 3D reconstructed surface and/or scene may be further refined (e.g., change in resolution, omit an object, reconstruct an object with finer detail, etc.). For example, the GUI 304 may support user-driven selective scene reconstruction by allowing a user to select one or more objects for targeted reconstructions. In some examples, a user selection may correspond to an area 306; in some examples, the user selection may correspond to a specific object, such as the table 308, chair 312, and/or floor 310.

In some aspects, a semantic segmentation network classifies pixels or surfaces into categories like floors, walls, etc. A user can then select a corresponding object directly. Alternately, a separate object detection neural network may identify bounding boxes around entities for selecting isolated items like furniture. Once selected, the image encoder 106 can identify associated pixels while unprojector 112 and point cloud generator 128 apply voxel back-projection and proximal point conversion to selectively encode target object geometry into output point cloud 130 representations for enhanced reconstruction views. For example, a user can indicate to include and/or not include certain objects in the 3D reconstruction. Those to include may be encoded into output point cloud 130. Those to not include may not be encoded into output point cloud 130. In some examples, rather than using depth map data for the reconstructed scene, depth information derived from 3D coordinates of the rendered scene (e.g., scene within GUI 304) can be used for voxel back-propagation and voxel thresholding purposes.

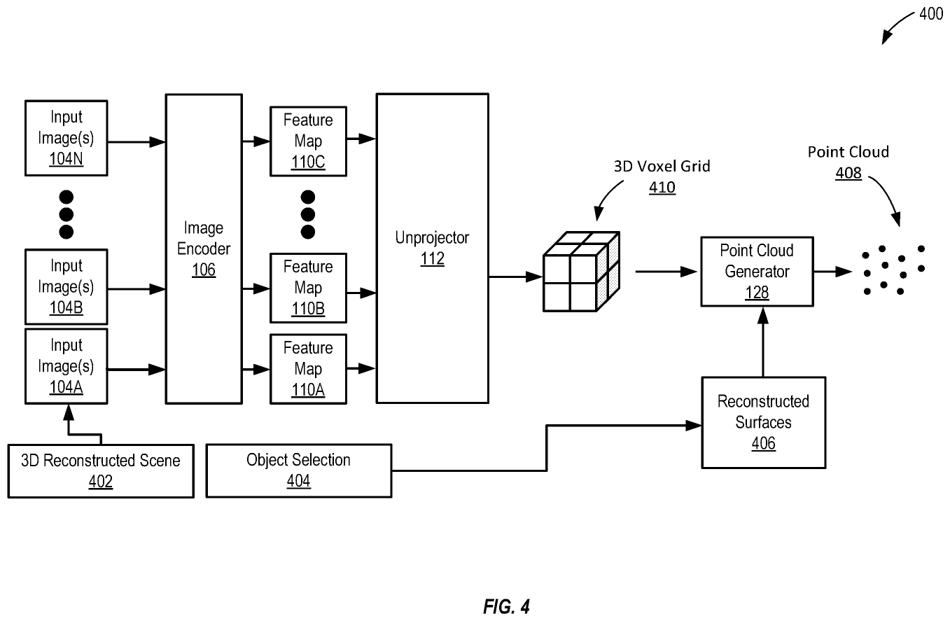

For example, FIG. 4 depicts an alternative implementation 400 for generating point cloud data leveraging a previously reconstructed 3D scene (e.g., scene depicted in FIG. 3) as input instead of images captured from the image sensor(s) 102 (FIG. 1). As illustrated, a previously generated 3D reconstructed scene 402 acts as the input. A user can interact with this 3D reconstructed scene 402 via object selections 404, allowing targeting of particular objects or areas for enhanced reconstruction. In certain aspects, the selection of objects guides the identification of voxels that are to be included in the point cloud 408. In examples, the point cloud generator 128 can increase point density specifically around selected areas to refine details only where desired. Operations follow similar steps as standard pipeline 100A—utilizing known visible surfaces from the existing 3D reconstructed scene 402 instead of depth maps 108 to provide depth information for surface/object proximity. In some examples, the 3D voxel grid 410 may have a resolution that is different from the 3D voxel grid 126 (FIG. 1A).

Output point cloud 408 representing user-driven selected objects can then undergo subsequent processing as described with respect to FIG. 1B. As previously mentioned, the object selection 404 allow targeted enhancement or omission of specific scene elements. Users may select a particular object of interest, such as chair 312 from FIG. 3, to indicate it should be reconstructed at higher precision. Such a selection can be directly indicated by a user (e.g., by selecting a particular object of interest) or can be selected semantically (e.g., selections based on the meaning or context of the items rather than explicit user selection). Based on this cue, the point cloud generator 128 can create a denser proximal voxel sampling for the object surface by utilizing a separate high-resolution voxel grid (e.g. 3D voxel grid 410) localized to an area around the selected object. Alternately, users may select objects to entirely omit from the reconstruction, such as table 308 from FIG. 3. Such a selection can be directly indicated by a user (e.g., by selecting a particular object to exclude) or can be excluded semantically (e.g., exclusions based on the meaning or context of the items rather than explicit user exclusion). By tagging surfaces as excluded, the point cloud generator 128 can skip proximal point sampling for designated object surfaces. This selectivity allows users to tailor scene visualizations via inclusion or exclusion of objects. In examples, the selection/exclusion of objects can be applied to the point cloud 130 and/or point cloud 408.

In some examples, the point cloud 130 (FIG. 1) and/or the point cloud 408 may be sampled uniformly over a specified area without regard to the number of points in the point cloud 130 (FIG. 1) and/or point cloud 408. In some examples, the point cloud 130 (FIG. 1) and/or the point cloud 408 may be sampled in accordance with a point cloud threshold, where a number of points in the point cloud utilized for reconstructing a surface is limited by the point cloud threshold. In some instances where the number of points in a point cloud exceeds the point cloud threshold, the point cloud 130 (FIG. 1) and/or point cloud 408 can be sampled at a different sampling interval to cover a relatively larger or more uniform area for reconstructing a surface while complying with the point cloud threshold.

### Example Artificial Intelligence System for 3D Scene Reconstruction

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

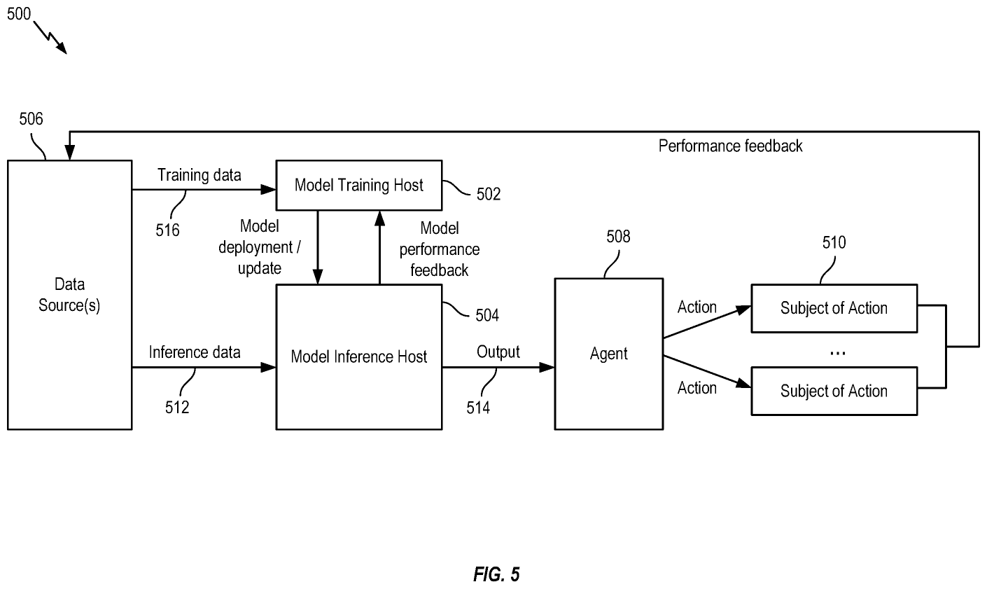

FIG. 5 is a diagram illustrating an example AI architecture 500 that may be used for performing 3D scene reconstruction as described above with respect to FIGS. 1A-4. As illustrated in FIG. 5, the architecture 500 includes multiple logical entities, such as a model training host 502, a model inference host 504, data source(s) 506, and an agent 508. The AI architecture may be used in any of various use cases for wireless communications, such as those listed above.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508.

The agent 508 may be an element or an entity of a wireless communication system including, for example, a radio access network (RAN), a wireless local area network, a device-to-device (D2D) communications system, etc. As an example, the agent 508 may be a user equipment (UE), a base station or any disaggregated network entity thereof including a centralized unit (CU), a distributed unit (DU), and/or a radio unit (RU)), an access point, a wireless station, a RAN intelligent controller (RIC) in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with beam management, the agent 508 may be or include a UE, a DU, or an RU. As another example, if output 514 from model inference host 504 is associated with transmission and/or reception scheduling, the agent 508 may be a CU or a DU.

After the agent 508 receives output 514 from the model inference host 504, agent 508 may determine whether to act based on the output. For example, if agent 508 is a DU or an RU and the output from model inference host 504 is associated with beam management, the agent 508 may determine whether to change or modify a transmit and/or receive beam based on the output 514. If the agent 508 determines to act based on the output 514, agent 508 may indicate the action to at least one subject of the action 510. For example, if the agent 508 determines to change or modify a transmit and/or receive beam for a communication between the agent 508 and the subject of action 510 (e.g., a UE), the agent 508 may send a beam switching indication to the subject of action 510 (e.g., a UE). As another example, the agent 508 may be a UE, the output 514 from model inference host 504 may be one or more predicted channel characteristics for one or more beams. For example, the model inference host 504 may predict channel characteristics for a set of beams based on the measurements of another set of beams. Based on the predicted channel characteristics, the agent 508, such as the UE, may send, to the subject of action 510, such as a BS, a request to switch to a different beam for communications. In some cases, the agent 508 and the subject of action 510 are the same entity.

The data sources 506 may be configured for collecting data that is used as training data 516 for training an ML model, or as inference data 512 for feeding an ML model inference operation. In particular, the data sources 506 may collect data from any of various entities (e.g., the UE and/or the BS), which may include the subject of action 510, and provide the collected data to a model training host 502 for ML model training. For example, after a subject of action 510 (e.g., a UE) receives a beam configuration from agent 508, the subject of action 510 may provide performance feedback associated with the beam configuration to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

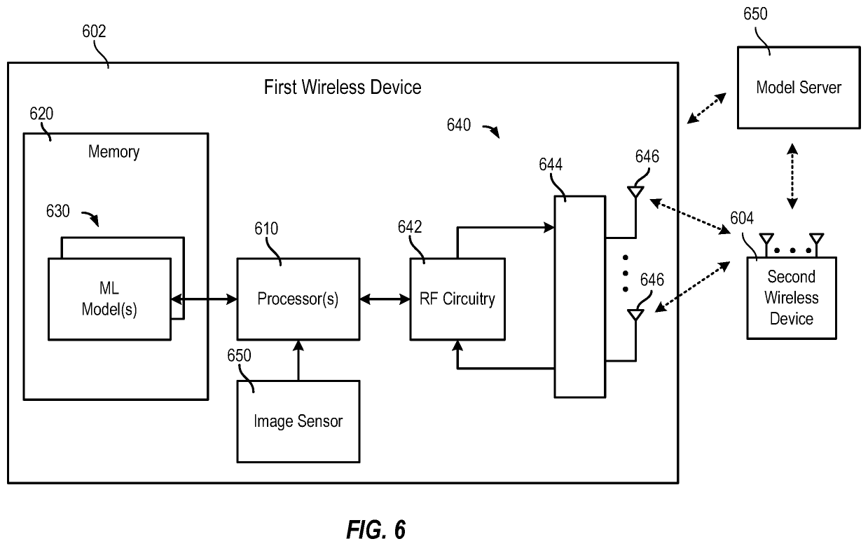

FIG. 6 illustrates an example AI architecture of a first wireless device 602 that is in communication with a second wireless device 604. The first wireless device 602 may be for performing 3D scene reconstruction as described herein with respect to FIGS. 1-5. Similarly, the second wireless device 604 may be for performing 3D scene reconstruction as described herein with respect to FIGS. 1-5. Note that the AI architecture of the first wireless device 602 may be applied to the second wireless device 604.

The first wireless device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

The first wireless device 602 may include an image sensor 650 coupled to processor 610.

As an example, in a transmit mode, the processor 610 may transform information (e.g., packets or data blocks) into modulated symbols. As digital baseband signals (e.g., digital in-phase (I) and/or quadrature (Q) baseband signals representative of the respective symbols), the processor 610 may output the modulated symbols to a transceiver 640. The processor 610 may be coupled to the transceiver 640 for transmitting and/or receiving signals via one or more antennas 646. In this example, the transceiver 640 includes radio frequency (RF) circuitry 642, which may be coupled to the antennas 646 via an interface 644. As an example, the interface 644 may include a switch, a duplexer, a diplexer, a multiplexer, and/or the like. The RF circuitry 642 may convert the digital signals to analog baseband signals, for example, using a digital-to-analog converter. The RF circuitry 642 may include any of various circuitry, including, for example, baseband filter(s), mixer(s), frequency synthesizer(s), power amplifier(s), and/or low noise amplifier(s). In some cases, the RF circuitry 642 may upconvert the baseband signals to one or more carrier frequencies for transmission. The antennas 646 may emit RF signals, which may be received at the second wireless device 604.

In receive mode, RF signals received via the antenna 646 (e.g., from the second wireless device 604) may be amplified and converted to a baseband frequency (e.g., downconverted). The received baseband signals may be filtered and converted to digital I or Q signals for digital signal processing. The processor 610 may receive the digital I or Q signals and further process the digital signals, for example, demodulating the digital signals.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 96% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the inference host 504 of FIG. 5. The ML model 630 may be used to perform any of various AI-enhanced tasks, such as those listed above.

As an example, the ML model 630 may generate TSDF values from input data. The input data may include, for example, voxels, input images, depth maps, and/or reconstructed scenes. The output data may include, for example, TSDF values corresponding to points in a point cloud as previously described. Note that other input data and/or output data may be used in addition to or instead of the examples described herein.

In certain aspects, a model server 650 may perform any of various ML model lifecycle management (LCM) tasks for the first wireless device 602 and/or the second wireless device 604. The model server 650 may operate as the model training host 502 of FIG. 5 and update the ML model 630 using training data. In some cases, the model server 650 may operate as the data source 506 of FIG. 5 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 to trigger one or more LCM tasks. For example, the model server 650 may determine whether to activate or deactivate the use of a particular ML model at the first wireless device 602 and/or the second wireless device 604, and the model server 650 may provide such an instruction to the respective first wireless device 602 and/or the second wireless device 604. In some cases, the model server 650 may determine whether to switch to a different ML model 630 being used at the first wireless device 602 and/or the second wireless device 604, and the model server 650 may provide such an instruction to the respective first wireless device 602 and/or the second wireless device 604. In yet further examples, the model server 650 may also act as a central server for decentralized machine learning tasks, such as federated learning.

### Example Artificial Intelligence Model

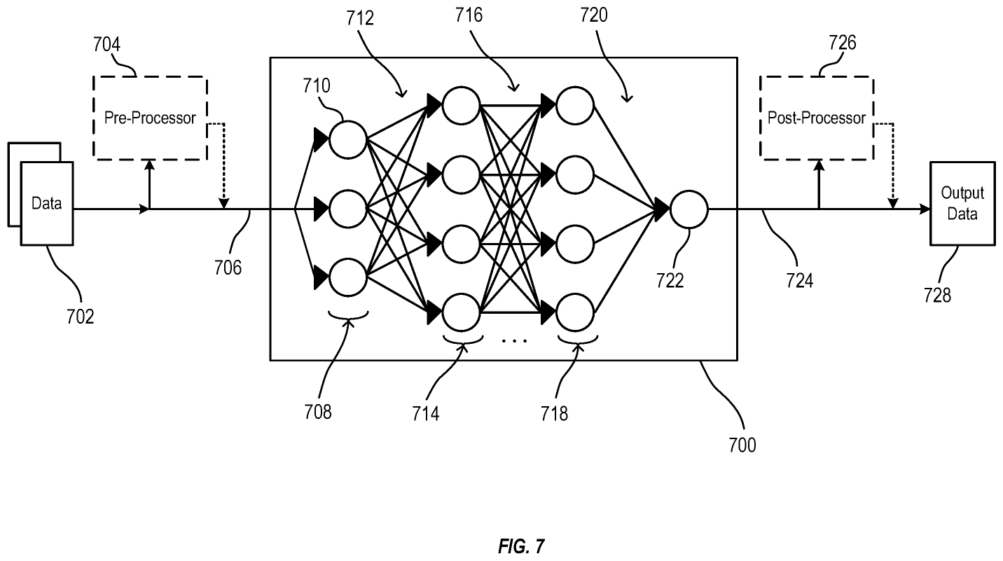

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 706 in FIG. 7). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 6 and 7. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 700 of FIG. 7.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a central unit (CU), a distributed unit (DU), a radio unit (RU), or the like.

### Example Method for Performing 3D Scene Reconstruction

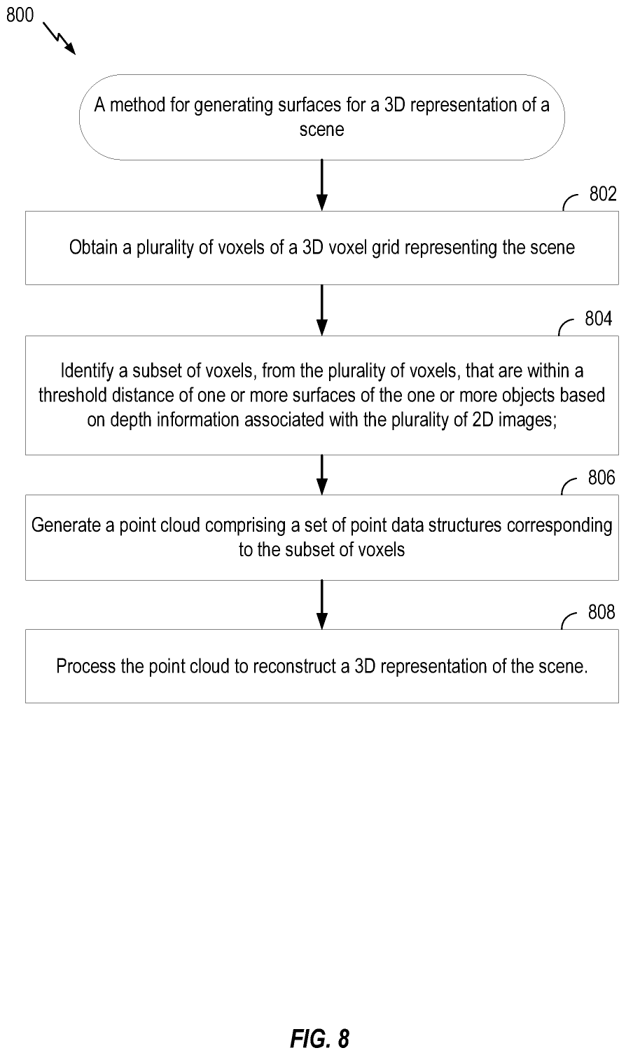

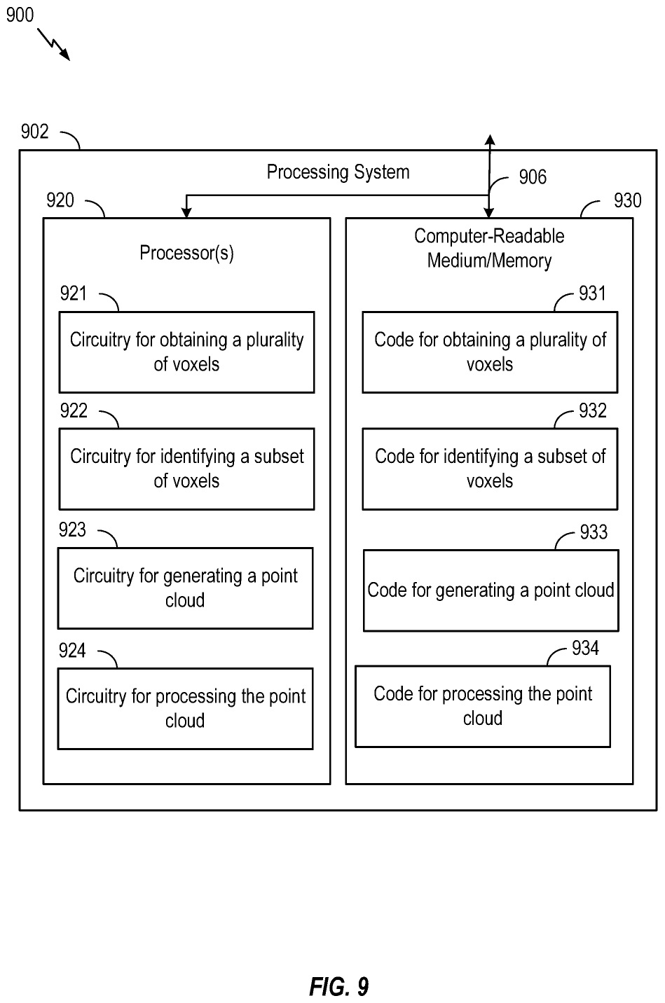

FIG. 8 shows a method 800 for performing 3D scene reconstruction. In one aspect, method 800, or any aspect related to it, may be performed by an apparatus, such as processing system 900 of FIG. 9, which includes various components operable, configured, or adapted to perform the method 800.

Method 800 begins at 802 with obtaining a plurality of voxels of a 3D voxel grid representing a scene including one or more objects.

The method 800 may then proceed to 804 with identifying a subset of voxels, from the plurality of voxels, that are within a threshold distance of one or more surfaces of the one or more objects based on depth information associated with a plurality of two-dimensional (2D) images of the scene.

The method 800 may then proceed to 806 with generating a point cloud comprising a set of point data structures corresponding to the subset of voxels.

The method 800 may then end at 808 with processing the point cloud to reconstruct a 3D representation of the scene.

In some embodiments of method 800, identifying the subset of voxels comprises: for each respective voxel of the subset of voxels, including the respective voxel in the subset of voxels based on a difference between a respective voxel distance from a viewpoint based on the 3D voxel grid and a respective depth value associated with the voxel based on the plurality of 2D images being less than the threshold distance.

In some embodiments of method 800, obtaining the plurality of voxels of the 3D voxel grid representing the scene comprises: generating, by an encoder, a plurality of encoded feature representations associated with the plurality of 2D images; and back-projecting the plurality of encoded feature representations into the plurality of voxels of the 3D voxel grid representing the scene

In some embodiments of method 800, back-projecting the plurality of encoded feature representations comprises: generating a 3D voxel position along a viewpoint ray extending between an origin point associated with an image capture device and an image pixel of a respective 2D image, the image pixel corresponding to a surface of the one or more surfaces of the one or more objects; and assigning one or more encoded feature representations of the plurality of encoded feature representations associated with the image pixel to a voxel of the plurality of voxels based on the 3D voxel position corresponding to a depth value of the voxel.

In some embodiments of method 800, the depth information associated with the plurality of 2D images includes per-pixel depth values for a plurality of pixels in the plurality of 2D images.

In some embodiments of method 800, the plurality of encoded feature representations comprise a plurality of feature vectors associated with pixels of the plurality of 2D images; and back-projecting the plurality of encoded feature representations comprises back-projecting the plurality of feature vectors into the plurality of voxels, guided by the per-pixel depth values.

In some embodiments of method 800, generating the plurality of encoded feature representations comprises: input the plurality of 2D images into a convolutional neural network encoder to generate at least one feature vector for each of a plurality of pixels of the plurality of 2D images.

In some embodiments of method 800, generating the point cloud comprises: creating a respective point data structure in the set of point data structures for each respective voxel in the subset of voxels, wherein the respective point data structure is associated with the respective voxel; and for each respective point data structure in the set of point data structures, storing: a corresponding 3D grid coordinate location of the associated respective voxel as a 3D position for the respective point data structure, and aggregated feature vectors associated with the associated respective voxel as point cloud feature vectors of the respective point data structure.

In some embodiments of method 800, processing the point cloud comprises, for each of one or more subsets of the set of point data structures: voxelizing local neighborhood point data structures of the subset of point data structures; performing 3D convolutions on the voxelized local neighborhood point data structures; and de-voxelizing outputs of the 3D convolutions to obtain aggregated feature vectors for the subset of point data structures.

In some embodiments of method 800, processing the point cloud comprises predicting a Truncated Signed Distance Function (TSDF) value for each respective point data structure of the set of point data structures based on the aggregated feature vectors.

In some embodiments of method 800, identifying the subset of voxels comprises not including each of one or more voxels of the plurality of voxels in the subset of voxels if a confidence score associated with an associated depth value of the voxel is less than a threshold.

In some embodiments, the method 800 further comprises: receiving input indicating a specified object of the one or more objects; and identifying pixels representing the specified object in the plurality of 2D images, wherein identifying the subset of voxels comprises not including voxels corresponding to the identified pixels in the subset of voxels.

In some embodiments of method 800, the reconstructed 3D representation of the scene excludes the specified object.

In some embodiments, the method 800 further comprises: receiving input indicating at least one object of the one or more objects; and identifying pixels representing at least one object in the plurality of 2D images, wherein identifying the subset of voxels comprises including voxels corresponding to the identified pixels in the subset of voxels.

In some embodiments of method 800, the reconstructed 3D representation of the scene includes the at least one object.

In some embodiments of method 800, processing the point cloud to reconstruct the 3D representation of the scene comprises utilizing a semantic label to reconstruct surfaces, of the one or more surfaces, corresponding to an object of the one or more objects with known geometric properties.

Note that FIG. 8 is just one example of a method, and other methods including fewer, additional, or alternative steps are possible consistent with this disclosure.

### Example Processing System for Performing 3D Scene Reconstruction

FIG. 9 depicts aspects of an example processing system 900.

The processing system 900 includes a processing system 902 includes one or more processors 920. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the method 800 described with respect to FIG. 8, or any aspect related to it, including any additional steps or sub-steps described in relation to FIG. 8.

In the depicted example, computer-readable medium/memory 930 stores code (e.g., executable instructions) for obtaining a plurality of voxels of a 3D voxel grid representing the scene 931, code for identifying a subset of voxels, from the plurality of voxels, that are within a threshold distance of one or more surfaces of the one or more objects based on depth information associated with the plurality of 2D images 932, code for generating a point cloud comprising a set of point data structures corresponding to the subset of voxels 933, and code for processing the point cloud to reconstruct a 3D representation of the scene 934. In some examples, the computer-readable medium/memory 930 may store code (e.g., executable instructions) for generating, by an encoder, a plurality of encoded feature representations associated with a plurality of 2D images, and code for back-projecting the plurality of encoded feature representations into a plurality of voxels of a 3D voxel grid representing the scene. Processing of the code 931-934 may enable and cause the processing system 900 to perform the method 800 described with respect to FIG. 8, or any aspect related to it.

The one or more processors 920 include circuitry configured to implement (e.g., execute) the code stored in the computer-readable medium/memory 930, including circuitry for obtaining a plurality of voxels of a 3D voxel grid representing the scene 921, circuitry for identifying a subset of voxels, from the plurality of voxels, that are within a threshold distance of one or more surfaces of the one or more objects based on depth information associated with the plurality of 2D images 922, circuitry for generating a point cloud comprising a set of point data structures corresponding to the subset of voxels 923, and circuitry for processing the point cloud to reconstruct a 3D representation of the scene 924. Processing with circuitry 921-924 may enable and cause the processing system 900 to perform the method 800 described with respect to FIG. 8, or any aspect related to it.

### Example Clauses

Implementation examples are described in the following numbered clauses:
Clause 1: A method for performing 3D scene reconstruction, comprising: obtaining a plurality of voxels of a 3D voxel grid representing a scene including one or more objects; identifying a subset of voxels, from the plurality of voxels, that are within a threshold distance of one or more surfaces of the one or more objects based on depth information associated with a plurality of two-dimensional (2D) images of the scene; generating a point cloud comprising a set of point data structures corresponding to the subset of voxels; and processing the point cloud to reconstruct a 3D representation of the scene.
Clause 2: A method in accordance with Clause 1, wherein identifying the subset of voxels comprises: for each respective voxel of the subset of voxels, including the respective voxel in the subset of voxels based on a difference between a respective voxel distance from a viewpoint based on the 3D voxel grid and a respective depth value associated with the voxel based on the plurality of 2D images being less than the threshold distance.
Clause 3: A method in accordance with any one of Clauses 1-2, wherein obtaining the plurality of voxels of the 3D voxel grid representing the scene comprises: generating, by an encoder, a plurality of encoded feature representations associated with the plurality of 2D images; and back-projecting the plurality of encoded feature representations into the plurality of voxels of the 3D voxel grid representing the scene.
Clause 4: A method in accordance with Clause 3, wherein back-projecting the plurality of encoded feature representations comprises: generating a 3D voxel position along a viewpoint ray extending between an origin point associated with an image capture device and an image pixel of a respective 2D image, the image pixel corresponding to a surface of the one or more surfaces of the one or more objects; and assigning one or more encoded feature representations of the plurality of encoded feature representations associated with the image pixel to a voxel of the plurality of voxels based on the 3D voxel position corresponding to a depth value of the voxel.
Clause 5: A method in accordance with Clause 4, wherein the depth information associated with the plurality of 2D images includes per-pixel depth values for a plurality of pixels in the plurality of 2D images.
Clause 6: A method in accordance with Clause 5, wherein the plurality of encoded feature representations comprise a plurality of feature vectors associated with pixels of the plurality of 2D images; and back-projecting the plurality of encoded feature representations comprises back-projecting the plurality of feature vectors into the plurality of voxels, guided by the per-pixel depth values.
Clause 7: A method in accordance with any one of Clauses 5-6, wherein to generating the plurality of encoded feature representations comprises: inputting the plurality of 2D images into a convolutional neural network encoder to generate at least one feature vector for each of a plurality of pixels of the plurality of 2D images.
Clause 8: A method in accordance with any one of Clauses 1-7, wherein generating the point cloud comprises: creating a respective point data structure in the set of point data structures for each respective voxel in the subset of voxels, wherein the respective point data structure is associated with the respective voxel; and for each respective point data structure in the set of point data structures, storing: a corresponding 3D grid coordinate location of the associated respective voxel as a 3D position for the respective point data structure, and aggregated feature vectors associated with the associated respective voxel as point cloud feature vectors of the respective point data structure.
Clause 9: A method in accordance with Clause 8, wherein processing the point cloud comprises, for each of one or more subsets of the set of point data structures: voxelizing local neighborhood point data structures of the subset of point data structures; performing 3D convolutions on the voxelized local neighborhood point data structures; and de-voxelizing outputs of the 3D convolutions to obtain aggregated feature vectors for the subset of point data structures.
Clause 10: A method in accordance with Clause 9, wherein processing the point cloud comprises predicting a Truncated Signed Distance Function (TSDF) value for each respective point data structure of the set of point data structures based on the aggregated feature vectors.
Clause 11: A method in accordance with any one of Clauses 1-10, wherein identifying the subset of voxels comprises to not include each of one or more voxels of the plurality of voxels in the subset of voxels if a confidence score associated with an associated depth value of the voxel is less than a threshold.
Clause 12: A method in accordance with any one of Clauses 1-11, further comprising: receiving input indicating a specified object of the one or more objects; and identifying pixels representing the specified object in the plurality of 2D images, wherein to identify the subset of voxels comprises to not include voxels corresponding to the identified pixels in the subset of voxels.
Clause 13: A method in accordance with Clause 12, wherein the reconstructed 3D representation of the scene excludes the specified object.
Clause 14: A method in accordance with any one of Clauses 1-13, further comprising: receiving input indicating at least one object of the one or more objects; and identifying pixels representing at least one object in the plurality of 2D images, wherein identifying the subset of voxels comprises to include voxels corresponding to the identified pixels in the subset of voxels.
Clause 15: A method in accordance with Clause 14, wherein the reconstructed 3D representation of the scene includes the at least one object.
Clause 16: A method in accordance with any one of Clauses 1-15, wherein processing the point cloud to reconstruct the 3D representation of the scene comprises utilizing a semantic label to reconstruct surfaces, of the one or more surfaces, corresponding to an object of the one or more objects with known geometric properties.
Clause 17: One or more apparatuses, comprising: one or more memories comprising executable instructions; and one or more processors configured to execute the executable instructions and cause the one or more apparatuses to perform a method in accordance with any one of clauses 1-16.
Clause 18: One or more apparatuses, comprising: one or more memories; and one or more processors, coupled to the one or more memories, configured to cause the one or more apparatuses to perform a method in accordance with any one of Clauses 1-16.
Clause 19: One or more apparatuses, comprising: one or more memories; and one or more processors, coupled to the one or more memories, configured to perform a method in accordance with any one of Clauses 1-16.
Clause 20: One or more apparatuses, comprising means for performing a method in accordance with any one of Clauses 1-16.
Clause 21: One or more non-transitory computer-readable media comprising executable instructions that, when executed by one or more processors of one or more apparatuses, cause the one or more apparatuses to perform a method in accordance with any one of Clauses 1-16.
Clause 22: One or more computer program products embodied on one or more computer-readable storage media comprising code for performing a method in accordance with any one of Clauses 1-16.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising:
one or more memories configured to store a plurality of two-dimensional (2D) images of a scene including one or more objects; and
one or more processors, coupled to the one or more memories, configured to:
obtain a plurality of voxels of a 3D voxel grid representing the scene;
identify a subset of voxels, from the plurality of voxels, that are within a threshold distance of one or more surfaces of the one or more objects based on depth information associated with the plurality of 2D images;
generate a point cloud comprising a set of point data structures corresponding to the subset of voxels; and
process the point cloud to reconstruct a 3D representation of the scene.

2. The apparatus of claim 1, wherein to identify the subset of voxels comprises to:
for each respective voxel of the subset of voxels, include the respective voxel in the subset of voxels based on a difference between a respective voxel distance from a viewpoint based on the 3D voxel grid and a respective depth value associated with the voxel based on the plurality of 2D images being less than the threshold distance.

3. The apparatus of claim 1, wherein to obtain the plurality of voxels of the 3D voxel grid representing the scene comprises to:
generate, by an encoder, a plurality of encoded feature representations associated with the plurality of 2D images; and
back-project the plurality of encoded feature representations into the plurality of voxels of the 3D voxel grid representing the scene.

4. The apparatus of claim 3, wherein to back-project the plurality of encoded feature representations comprises to:
generate a 3D voxel position along a viewpoint ray extending between an origin point associated with an image capture device and an image pixel of a respective 2D image, the image pixel corresponding to a surface of the one or more surfaces of the one or more objects; and
assign one or more encoded feature representations of the plurality of encoded feature representations associated with the image pixel to a voxel of the plurality of voxels based on the 3D voxel position corresponding to a depth value of the voxel.

5. The apparatus of claim 3, wherein the depth information associated with the plurality of 2D images includes per-pixel depth values for a plurality of pixels in the plurality of 2D images.

6. The apparatus of claim 5, wherein:
the plurality of encoded feature representations comprise a plurality of feature vectors associated with pixels of the plurality of 2D images; and
to back-project the plurality of encoded feature representations comprises to back-project the plurality of feature vectors into the plurality of voxels, guided by the per-pixel depth values.

7. The apparatus of claim 5, wherein to generate the plurality of encoded feature representations comprises to:
input the plurality of 2D images into a convolutional neural network encoder to generate at least one feature vector for each of a plurality of pixels of the plurality of 2D images.

8. The apparatus of claim 1, wherein to generate the point cloud comprises to:
create a respective point data structure in the set of point data structures for each respective voxel in the subset of voxels, wherein the respective point data structure is associated with the respective voxel; and
for each respective point data structure in the set of point data structures, store:
a corresponding 3D grid coordinate location of the associated respective voxel as a 3D position for the respective point data structure, and
aggregated feature vectors associated with the associated respective voxel as point cloud feature vectors of the respective point data structure.

9. The apparatus of claim 8, wherein to process the point cloud comprises to, for each of one or more subsets of the set of point data structures:
voxelize local neighborhood point data structures of the subset of point data structures;
perform 3D convolutions on the voxelized local neighborhood point data structures; and
de-voxelize outputs of the 3D convolutions to obtain aggregated feature vectors for the subset of point data structures.

10. The apparatus of claim 9, wherein to process the point cloud comprises to predict a Truncated Signed Distance Function (TSDF) value for each respective point data structure of the set of point data structures based on the aggregated feature vectors.

11. The apparatus of claim 1, wherein to identify the subset of voxels comprises to not include each of one or more voxels of the plurality of voxels in the subset of voxels if a confidence score associated with an associated depth value of the voxel is less than a threshold.

12. The apparatus of claim 1, wherein the one or more processors are configured to:
receive input indicating a specified object of the one or more objects; and
identify pixels representing the specified object in the plurality of 2D images, wherein to identify the subset of voxels comprises to not include voxels corresponding to the identified pixels in the subset of voxels.

13. The apparatus of claim 12, wherein the reconstructed 3D representation of the scene excludes the specified object.

14. The apparatus of claim 1, wherein the one or more processors are configured to:
receive input indicating at least one object of the one or more objects; and
identify pixels representing at least one object in the plurality of 2D images, wherein to identify the subset of voxels comprises to include voxels corresponding to the identified pixels in the subset of voxels.

15. The apparatus of claim 14, wherein the reconstructed 3D representation of the scene includes the at least one object.

16. The apparatus of claim 1, wherein to process the point cloud to reconstruct the 3D representation of the scene comprises to utilize a semantic label to reconstruct surfaces, of the one or more surfaces, corresponding to an object of the one or more objects with known geometric properties.

17. A method for performing 3D scene reconstruction, the method comprising:
obtaining a plurality of voxels of a 3D voxel grid representing a scene including one or more objects;
identifying a subset of voxels, from the plurality of voxels, that are within a threshold distance of one or more surfaces of the one or more objects based on depth information associated with a plurality of two-dimensional (2D) images of the scene;
generating a point cloud comprising a set of point data structures corresponding to the subset of voxels; and
processing the point cloud to reconstruct a 3D representation of the scene.

18. The method of claim 17, wherein identifying the subset of voxels comprises: for each respective voxel of the subset of voxels, including the respective voxel in the subset of voxels based on a difference between a respective voxel distance from a viewpoint based on the 3D voxel grid and a respective depth value associated with the voxel based on the plurality of 2D images being less than the threshold distance.

19. The method of claim 17, wherein obtaining the plurality of voxels of the 3D voxel grid representing the scene comprises:
generating, by an encoder, a plurality of encoded feature representations associated with the plurality of 2D images; and
back-projecting the plurality of encoded feature representations into the plurality of voxels of the 3D voxel grid representing the scene.

20. A non-transitory computer-readable medium comprising instructions, which when executed by one or more processors, cause the one or more processors to perform operations comprising:
obtaining a plurality of voxels of a 3D voxel grid representing a scene including one or more objects;
identifying a subset of voxels, from the plurality of voxels, that are within a threshold distance of one or more surfaces of the one or more objects based on depth information associated with a plurality of two-dimensional (2D) images of the scene;
generating a point cloud comprising a set of point data structures corresponding to the subset of voxels; and
processing the point cloud to reconstruct a 3D representation of the scene.
